(19) United States
(12) Patent Application Publication
(10) Pub. No.: US 2001/0022893 A1
(43) Pub. Date: Sep. 20, 2001

(54) DIGITAL AUDIO/VIDEO DISK RECORDER WITH PRE-RECORD FUNCTION

(76) Inventor: GLENN SANDERS, FRANKLIN LAKES, NJ (US)

Correspondence Address: ABELMAN FRAYNE & SCHWAB, 150 EAST, 42ND STREET, NEW YORK, NY, 100175612

(21) Appl. No.: 09/047,138

(22) Filed: Mar. 24, 1998

(51) Int. Cl. H04N 5/92; H04N 5/781

(52) U.S. Cl. 386/112; 386/125

(57) ABSTRACT

A digital audio/video disk recorder allows faster than real time recordation of audio/video data and the recordation of audio/video data before the activation of a record function. A Random Access Memory (RAM) buffer records audio/video data on a continuous basis so that such data has been recorded before the record function has been activated. Time code data based upon time code generated by a time code generator, the time code data accurately reflecting the presence of pre-record data, is saved to disk storage along with the audio/video data recorded.

### BACKGROUND OF THE INVENTION

1. Field of the Invention

This invention relates to the field of devices for recording information in digital form to permanent disk media, and, in particular, to the field of such devices with a facility of obtaining recordings of audio/video data.

2. Description of the Related Art

Recording devices capable of recording audio/video data in digital form on disk media are well known in the art. However, it is often desired to obtain recordings of spontaneous or other unscheduled events in real time.

For example, one may wish to record in real time both visually and aurally a thunderstorm or another natural event occurring at unpredictable times. In such a case, it would be very desirable to be able to record parts of a natural event upon the pressing of a record button or other means for initiating recording on such a recording device, the recording to include a part of the natural event occurring a brief time prior to the pressing of the record button.

However, recording devices capable of recording audio and video data in digital form to disk media only record events occurring after the activation of the means to signal the device to initiate recording.

A schematic diagram of a typical device capable of recording digital video and audio data to disk storage media is shown in FIG. 1. The digital audio/video disk recorder comprises an optional analog to digital converter 4, a digital signal processor 6, a time code generator 8, disk storage 10, a Random Access Memory (RAM) buffer 11, and a control panel 12. Assuming power to the device is on, a user initiates recording by the device through an activation means on the control panel 12. Upon such activation of the device 2, audio/video input data 14 in an analog form is received by the device and converted to a digital form by an analog to digital converter 4. Alternatively, audio/video input data may be received directly in a digital form, making an analog to digital converter 4 unnecessary. The digital data is forwarded by the device to a digital signal processor 6 which places the digital audio/video data in a format capable of being stored on a disk or other equivalent media, and the data is then forwarded by the digital signal processor 6 to disk storage 10. The digital audio/video data may also be temporarily stored on the RAM buffer 11 by the digital signal processor 6 prior to permanent storage on disk storage 10. A time code representing the time at which the digital audio/video data begins is generated by a time code generator 8 and is forwarded by the time code generator 8 to the digital signal processor 6 which in turn writes it to disk storage 10. The data ultimately stored on disk storage will commence at substantially the same time as any record function on the control panel is activated.

The invention disclosed herein provides an apparatus for capturing audio/video data such that digital audio/video data stored on a digital audio/video recorder commences a pre-record time of, for example, 1-10 seconds in the embodiment described below or, in general, a pre-record time less than or equal to a time corresponding to the physical memory capacity of a RAM buffer, before the activation of any record function on that recorder.

### SUMMARY OF THE INVENTION

The apparatus disclosed herein allows the recording of digital audio/video data on disk storage means or other equivalent means beginning a time defined by a pre-record function before the activation of recording initiating means on the digital audio/video disk recorder.

The device comprises a RAM buffer which enables such pre-recording of digital audio/video data. In addition, the digital signal processor places an appropriate time code on disk storage based upon a time code generated by a time code generator and the RAM buffer length. Upon playback of the audio/video data, the time displayed on the control panel corresponding to a certain position in the audio/video data takes into account the prerecorded portion of the audio/video data.

It is an object of the invention to provide for faster than real time recordation of audio/video data.

It is a further object of the invention to provide for recordation of audio/video data by the recordation of such data before a record function is activated and by the proper adjustment of the time code displayed based upon such pre-record data.

It is a further object of the invention to provide a RAM buffer continually recording audio/video data to implement the pre-record function of the device and to allow faster than real time recordation of audio/video data.

It is yet a further object of the invention to record data before the record function is activated such that recorded data is played back with the data recorded both before and after the record function is activated being in the order in which it was recorded.

It is still a further object of the invention to store with such pre-recorded data a time code properly stating the time of beginning of such pre-record data. Other objects of the invention will become apparent upon reading and examination of this application and the appended drawings.

### BRIEF DESCRIPTION OF THE DRAWINGS

FIG. 1 is a schematic diagram of a conventional digital audio/video disk recorder.

FIG. 2 is a schematic diagram of a digital audio/video disk recorder with a pre-record function.

FIGS. 3A and 3B are a flow chart of the operation of an embodiment of the invention.

FIG. 4 is a schematic diagram of a RAM buffer of a digital audio/video disk recorder with a pre-record function.

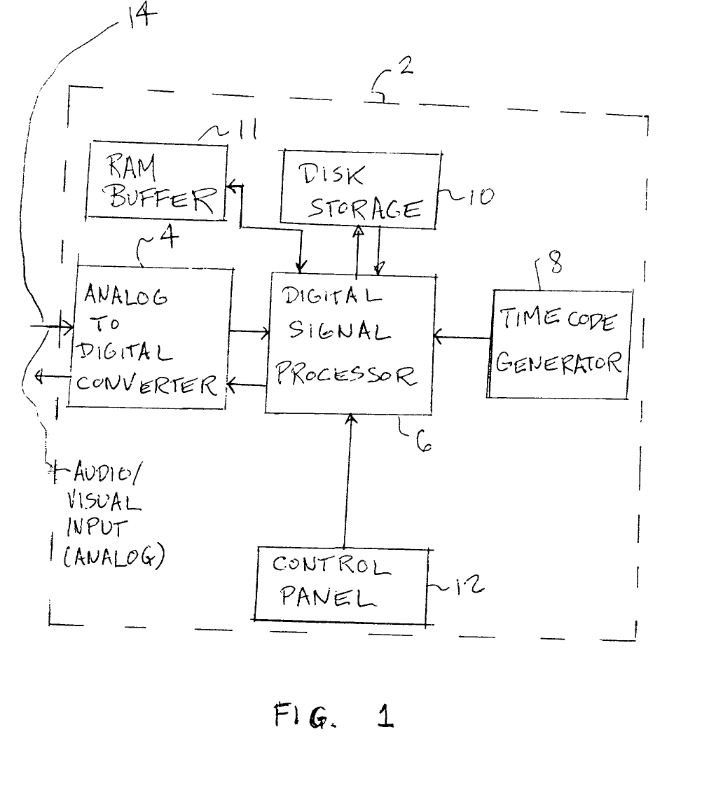

### DESCRIPTION OF THE PREFERRED EMBODIMENT

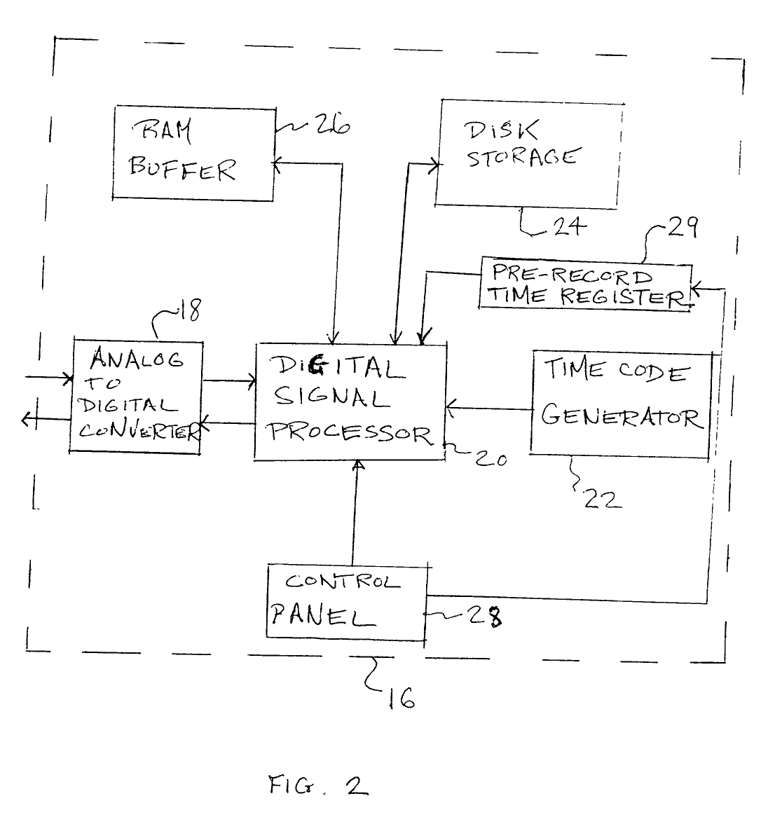

A schematic diagram of the device disclosed herein is shown in FIG. 2. A digital audio/video disk recorder (DAVDR) 16 comprises an optional analog to digital converter 18, a digital signal processor (DSP) 20, a time code generator (TCG) 22, disk storage 24, a RAM buffer 26, and a control panel 28, which are the same components in any conventional digital audio/video disk recorder as previously described. However, the disclosed device also comprises a Pre-Record Time Register (PRTR) 29 which controls the length of pre-record time. The length of pre-record time is adjustable by the user within a limit to be specified later.

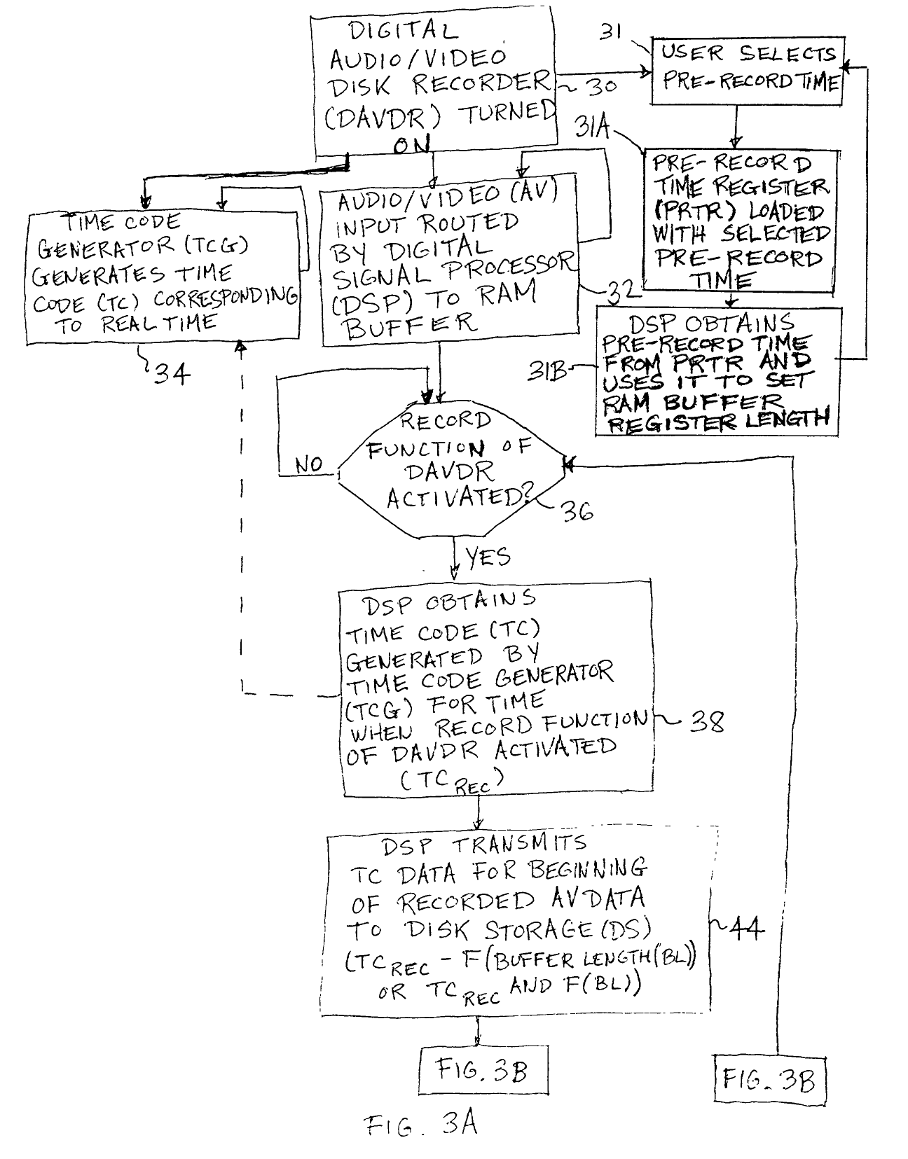

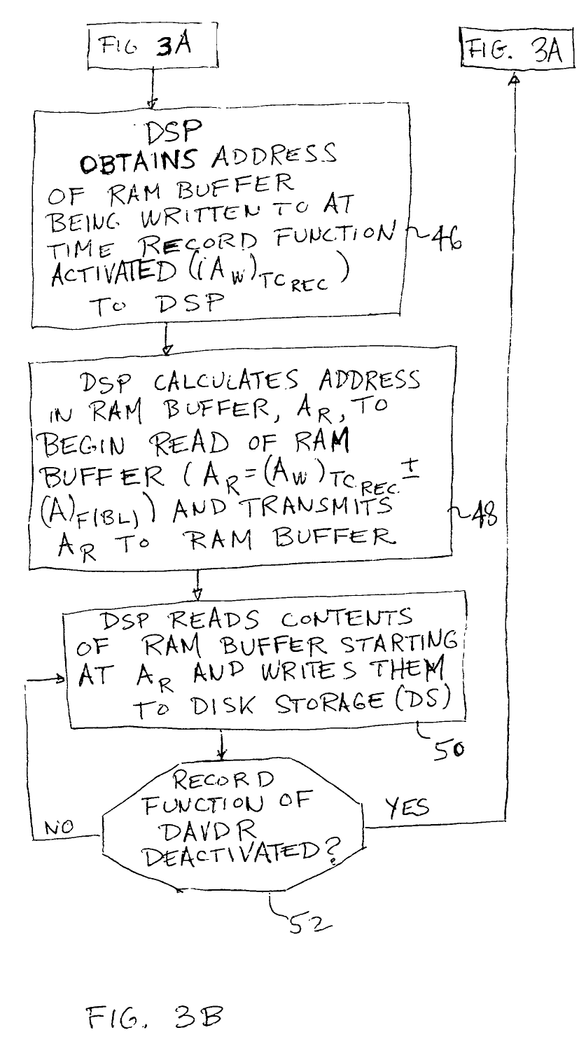

An explanation of the operation of the DAVDR with its pre-record function recording audio/video (AV) data into the RAM buffer and allowing faster than real time recording is illustrated in the flow charts shown in FIGS. 3A and 3B. The explanation of operations set forth below should be understood to be exemplary only and should not be construed to be a limitation on the invention disclosed herein.

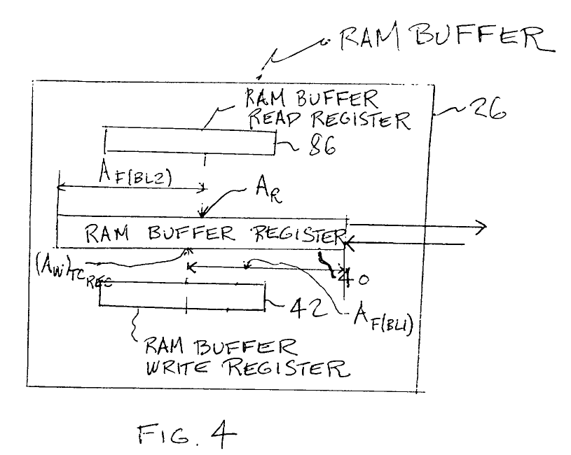

The operation of the DAVDR begins, of course, when it is turned on 30. After the DAVDR is turned on, the user can select a pre-record time of any length, provided, however, that the pre-record time selected does not cause the RAM buffer register 40 length (see FIG. 4) to exceed the actual physical memory available to the RAM buffer 26. (Typical values of such pre-record time selected are from one to ten seconds.) The user selects the pre-record time by appropriate means on the control panel 28 (step 31) which causes the PRTR 29 to be loaded with the selected pre-record time (step 31A). Alternatively, the pre-record time may be loaded onto the PRTR 29 by a device external to the DAVDR. The DSP obtains the pre-record time from the PRTR 29 and uses it to set the RAM buffer register 40 length (step 31B).

In addition, as soon as the DAVDR is turned on, AV input received by the DAVDR is passed through the optional analog to digital converter 18, received by the digital signal processor (DSP) 20, and routed by the DSP 20 to the RAM buffer 26 (step 32, FIG. 3A). Such receipt and routing of AV input is a continuous process while the DAVDR remains on as is indicated by the self loop shown for the box in FIG. 3A labelled 32. Since the RAM buffer register 40 is of a set length (see FIG. 4) after the selection of the pre-record time, new AV data overwrites old AV data in the RAM buffer register 40 in “endless loop” fashion as the data written reaches one end of the RAM buffer register 40 and then proceeds to be written at the opposite end. A RAM buffer write register 42, the contents of which are controlled by the DSP 20, keeps track of the current address in the RAM buffer register 40 to which the writing of data is occurring.

In addition to the continuous process of writing AV input to the RAM buffer, another continuous process involving the Time Code Generator (TCG) is initiated once the DAVDR is turned on. The TCG continuously generates Time Code (TC) corresponding to real time 34. It should be noted that the function of the TCG may be performed by a device external to the DAVDR and, therefore, an internal TCG is not necessary. The relevance of the Time Code to the functioning of the invention will become clear presently.

As the processes involving the RAM buffer and the TCG proceed continuously, a test is made to determine whether the record function of the DAVDR has been activated. The test is repeated until it has been passed. When it is found that the record function of the DAVDR has been activated, the DSP first obtains Time Code (TC) generated by the TCG for the time when the record function of the DAVDR was activated, TC_{REC}, 38.

Second, the DSP transmits time code data for the beginning of the recorded AV data to disk storage 44. This time code data is either time code corresponding to the time the record function was activated, TC_{REC}, minus a time offset, F(BL), which is a function of the buffer length of the RAM buffer register 40, or the time code when the record function was activated, TC_{REC}, and the same time offset previously mentioned. The buffer length of the RAM buffer register 40 is adjustable and is a function of the selected pre-record time. However, as previously mentioned, the adjustable RAM buffer register 40 length must be less than or equal to the actual physical memory available to the RAM buffer 26. The previously mentioned time offset, which is a function of the buffer length of the RAM buffer register 40, is a time which is slightly less than the time corresponding to the full capacity of AV data of the RAM buffer register 40 (typically about 1-10 seconds). The slight decrease in the time corresponding to the full data capacity of the RAM buffer register 40 is substantially equal to the slight time delay between the time that the record function of the DAVDR is activated and the time that the DSP starts to read the RAM buffer register 40. The decrease in time offset from the RAM buffer register 40 length insures that the address of the RAM buffer register 40 being written to never “catches up” to the address at which reading occurs, thereby avoiding overwriting of unread data. When the audio/video data recorded is played back, the time displayed on the control panel accurately takes into account the pre-record data through an adjustment based on the time code data written to disk storage 44.

Third, the DSP will obtain the address of the RAM buffer register 40 being written to at the time the record function is activated, (A_{W})_{TC}_{_{REC}}, (step 46). (A_{W})_{TC}_{_{REC}} will simply be the contents of the RAM buffer write register 42 at the time the record function is activated.

Fourth, the DSP calculates the address in the RAM buffer, A_{R}, to begin the reading of the RAM buffer, and transmits AR to the RAM buffer 48. A_{R} is calculated using the address of the RAM buffer being written to at the time the record function is activated, (A_{W})_{TC}_{_{REC}}, which was obtained from the RAM buffer 26 by the DSP 20 (step 46). The expression for A_{R} is:

A_{R}=(A_{W})_{TC}_{_{REC}}±(A)_{F(BL)}

The appearance of the ± sign in the expression for A_{R} indicates that, depending upon the configuration of the data in the RAM buffer register 40, it may be necessary to subtract or add (A)_{F(BL)} to arrive at A_{R}. The expression (A)_{F(BL)} represents the address offset corresponding to the time offset, which is a function of the buffer length, F(BL). FIG. 4 shows graphically the relationship between A_{R}, (A_{W})_{TC}_{_{REC}}, and (A)_{F(BL)} where (A)_{F(BL)}=(A)_{F(BL1)}+(A)_{F(BL2)}. A_{R} is held in the RAM buffer read register 86. The address in the RAM buffer read register 86 is incremented continuously from A_{R} by the DSP 20 as the read proceeds and thus the RAM buffer read register 86 continuously keeps track of the memory address in the RAM buffer register 40 to be read.

The DSP reads the contents of the RAM buffer register 40 and writes those contents to disk storage 24 (step 50). This process of reading the contents of the RAM buffer and writing them to disk storage continues until the record function of the DAVDR is deactivated 52. The RAM buffer is initially read by the DSP at a faster rate than the rate at which new AV data is being written to the RAM buffer to insure that no data to be read is overwritten before it is read.

Since the RAM buffer register 40 is initially read at an address, A_{R}, corresponding to a time given by the time the record function of the DAVDR is activated minus the previously mentioned time offset, the time offset being slightly less than the time corresponding to the RAM buffer register 40 length, or at a time expressed by TC_{REC}−F(BL), the DAVDR is thus equipped with a “pre-record function” that places material recorded before the record function of the DAVDR is activated onto the disk storage. This results in no omission of recorded data from the time the pre-recorded data begins. Thus, recorded data recorded before the record function is activated to the extent of nearly the full length of the RAM buffer register 40 is placed on disk storage after the record function is activated. The fact that the DSP initially reads the RAM buffer register 40 at a faster rate than the RAM buffer register 40 is being written to by new AV data results in the address value of the RAM buffer read register 86 eventually “catching up” with the address value in the RAM buffer write register 42. When these two values are equal, the rate of reading the RAM buffer register 40 is decreased by the DSP 20 to the rate of writing to the RAM buffer register 40 for the rest of the recording session. Overall faster than real time recordation of data is achieved due to the initial reading of the RAM buffer register 40 at a faster rate than it is being written to by new AV data.

Although this invention has been described by this preferred embodiment, various modifications and changes would be obvious to those with ordinary skill in the art which are intended to be covered by the foregoing disclosure and the appended claims.

What is claimed is:

1. A digital audio/video disk recorder comprising:
a. a digital signal processor adapted to receive audio/video input data in digital form;
b. a control panel adapted to activate a record function of said digital audio/video disk recorder;
c. disk storage adapted to permanently store said audio/video input data in digital form received from said digital signal processor; and
d. a random access memory (RAM) buffer adapted to continually store said audio/video input data in digital form received from said digital signal processor.

2. A digital audio/video disk recorder as claimed in claim 1, further comprising a time code generator adapted to generate time code to be made available to said digital signal processor.

3. A digital audio/video disk recorder as claimed in claim 1, wherein a time code generator external to said digital audio/video disk recorder, said time code generator being adapted to generate time code, makes available said time code to said digital signal processor.

4. A digital audio/video disk recorder as claimed in claim 2, wherein said RAM buffer is used to create a RAM buffer register of adjustable length adapted to store audio/video data before and after the activation of said record function of said digital audio/video disk recorder, thereby providing for a pre-record function.

5. A digital audio/video disk recorder as claimed in claim 4, wherein said adjustable length of said RAM buffer register is determined by a selected pre-record time contained in a pre-record time register, said pre-record time register receiving said selected pre-record time from said control panel, said digital signal processor obtaining said selected pre-record time from said pre-record time register.

6. A digital audio/video disk recorder as claimed in claim 4, wherein said adjustable length of said RAM buffer register is determined by a pre-record time contained in a pre-record time register, said pre-record time register receiving said pre-record time from a device external to said digital audio/video disk recorder, said digital signal processor obtaining said pre-record time from said pre-record time register.

7. A digital audio/video disk recorder as claimed in claim 5, wherein said control panel is adapted to enable a user to enter said selected pre-record time.

8. A digital audio/video disk recorder as claimed in claim 5, wherein said digital signal processor is adapted to use said selected pre-record time to set said adjustable length of said RAM buffer register.

9. A digital audio/video disk recorder as claimed in claim 4, wherein said digital signal processor is adapted to write audio/video data to said RAM buffer register and to read audio/video data from said RAM buffer register, said read audio/video data being written by said digital signal processor to said disk storage.

10. A digital audio/video disk recorder as claimed in claim 9, wherein said reading of audio/video data can occur at a greater rate than said writing of audio/video data.

11. A digital audio/video disk recorder as claimed in claim 9, wherein said digital signal processor is adapted to transmit time code data to said disk storage, said time code data specifying a time of beginning of said read audio/video data.

12. A digital audio/video disk recorder as claimed in claim 11, wherein said time code data is based upon time code generated by said time code generator corresponding to a time of activation of said record function of said digital audio/video disk recorder.

13. A digital audio/video disk recorder as claimed in claim 12, wherein said time code data is equal to said time code minus a time offset which is a function of said adjustable buffer length of said RAM buffer register.

14. A digital audio/video disk recorder as claimed in claim 13, wherein said digital signal processor begins to read audio/video data from said RAM buffer register after said time of activation of said record function at an address of said RAM buffer register equal to an address of said RAM buffer register being written to at said time of activation minus an address offset corresponding to said time offset.

15. A digital audio/video disk recorder as claimed in claim 13, wherein said digital signal processor begins to read audio/video data from said RAM buffer register after said time of activation of said record function at an address of said RAM buffer register equal to an address of said RAM buffer register being written to at said time of activation plus an address offset corresponding to said time offset.

16. A digital audio/video disk recorder as claimed in claim 9, wherein said written audio/video data to said RAM buffer register overwrites previously written audio/video data in said RAM buffer register after said RAM buffer register initially becomes filled with audio/video data.

17. A digital audio/video disk recorder as claimed in claim 5, wherein said digital signal processor is adapted to write audio/video data to said RAM buffer register and to read audio/video data from said RAM buffer register, said read audio/video data being written by said digital signal processor to said disk storage.

18. A digital audio/video disk recorder as claimed in claim 17, wherein said reading of audio/video data can occur at a greater rate than said writing of audio/video data.

19. A digital audio/video disk recorder as claimed in claim 17, wherein said digital signal processor is adapted to transmit time code data to said disk storage, said time code data specifying a time of beginning of said read audio/video data.

20. A digital audio/video disk recorder as claimed in claim 19, wherein said time code data is based upon time code generated by said time code generator corresponding to a time of activation of said record function of said digital audio/video disk recorder.

21. A digital audio/video disk recorder as claimed in claim 20, wherein said time code data is equal to said time code minus a time offset which is a function of said adjustable buffer length of said RAM buffer register.

22. A digital audio/video disk recorder as claimed in claim 19, wherein said adjustable buffer length of said RAM buffer register is a function of said selected pre-record time.

23. A digital audio/video disk recorder as claimed in claim 22, wherein said digital signal processor begins to read audio/video data from said RAM buffer register after said time of activation of said record function at an address of said RAM buffer register equal to an address of said RAM buffer register being written to at said time of activation minus an address offset corresponding to said time offset.

24. A digital audio/video disk recorder as claimed in claim 22, wherein said digital signal processor begins to read audio/video data from said RAM buffer register after said time of activation of said record function at an address of said RAM buffer register equal to an address of said RAM buffer register being written to at said time of activation plus an address offset corresponding to said time offset.

25. A digital audio/video disk recorder as claimed in claim 17, wherein said written audio/video data to said RAM buffer register overwrites previously written audio/video data in said RAM buffer register after said RAM buffer register initially becomes filled with audio/video data.
